(19) United States
(12) Patent Application Publication
(10) Pub. No.: US 2007/0196242 A1
(43) Pub. Date: Aug. 23, 2007

(54) Used test strip storage container

(75) Inventors: Brad Boozer, Marblehead, MA (US); Joseph Flaherty, Westford, MA (US); Timothy Golnik, Boxford, MA (US)

Correspondence Address: Marina Larson & Associates, LLC, P.O. BOX 4928, DILLON, CO, 80435, US

(73) Assignee: AgaMatrix, Inc., Salem, NH (US)

(21) Appl. No.: 11/677,701

(22) Filed: Feb. 22, 2007

Related U.S. Application Data
(60) Provisional application No. 60/743,348, filed on Feb. 23, 2006.

(51) Int. Cl. B01L 9/00

(52) U.S. Cl. 422/102; 422/104

(57) ABSTRACT

A storage container for storing used diagnostic test strips has a base wall, a top wall, and a side wall that define an enclosed container space. The container has formed therein a test strip opening that connects the outside environment with the enclosed container space. The test strip opening is sized to receive a test strip and allow its passage from the outside environment to the enclosed container space. The test strip opening is disposed on the container in a position to restrain a test strip disposed in the container space from falling out of the container through the test strip opening, or the test strip opening is shaped to restrain a test strip disposed in the container space from falling out of the container through the test strip opening, or both.

### CROSS REFERENCE TO RELATED APPLICATION

The present application is a non-provisional application of U.S. provisional application No. 60/743,348 which was filed on Feb. 23, 2006 and is herein incorporated by reference for all purposes.

### BACKGROUND

Test strips for medical diagnostic purposes are typically supplied and carried in vials from which they are removed as required by a user, for example, when a diagnostic test is to be carried out. Typical types of test strips include those used for measuring the concentration of an analyte, such as glucose, in a human fluid, such as blood. After a user performs a diagnostic test using a diagnostic test strip, the test strip is typically discarded because it is not reusable. Since a used test strip contains a bodily fluid, e.g. blood, it is desirable to discard it in a safe and sanitary way since known pathogens, like AIDS or Hepatitis, may be present in an individual user's blood. Test strip containers currently available on the market are supplied to consumers with a single chamber to hold unused and sterile strips. Users of such containers must have a waste receptacle at hand every time they test a sample, to dispose of a used test strip, which for some users may occur as much as 10-20 times per day. It can be difficult to find access to waste receptacles, especially for users on the go, who are constantly moving from place to place. It would therefore be desirable to have a device that allows for the safe and sanitary storage of used test strips until such a time as when they can be properly disposed of.

### SUMMARY OF THE INVENTION

The present invention provides a safe and sanitary storage container that allows a user to store used diagnostic test strips. The container allows a user to carry with them at all times a disposal device that receives used test strips. In one embodiment, a storage container for storing used diagnostic test strips is provided that comprises a base wall, a top wall, and a side wall defining an enclosed container space. The container has formed therein a test strip opening connecting the outside environment with the enclosed container space, wherein the test strip opening is sized to receive a test strip and allow its passage from the outside environment to the enclosed container space. The test strip opening is: disposed on the container in a position to restrain a test strip disposed in the container space from falling out of the container through the test strip opening; shaped to restrain a test strip disposed in the container space from falling out of the container through the test strip opening; or both. In another embodiment the container further comprises an unused test strip compartment comprising a plurality of unused test strips. The present invention also provides a method of used the container.

### BRIEF DESCRIPTION OF THE DRAWINGS

FIG. 1 is an isometric view of a container in accordance with the present invention.

FIG. 2 is a side view of a container in accordance with the present invention.

FIG. 3 is a bottom view of a container in accordance with the present invention.

FIG. 4 is a side view of a container in accordance with the present invention.

FIG. 5 is a side view of a container in accordance with the present invention.

FIG. 6A is a side view of a container wall in accordance with the present invention.

FIG. 6B is a side view of a container wall in accordance with the present invention.

FIG. 6C is a side view of a container wall in accordance with the present invention.

FIG. 7A is a side view of a container in accordance with the present invention.

FIG. 7B is a side view of a container in accordance with the present invention.

FIG. 8 is a cross-section view of a container in accordance with the present invention.

FIG. 9A is a cross-section view of a container in accordance with the present invention.

FIG. 9B is a cross-section view of a container in accordance with the present invention.

FIG. 10A is an isometric view of a container in accordance with the present invention.

FIG. 10B is a cross-section view of a container in accordance with the present invention.

FIG. 11 is a side view of a container in accordance with the present invention.

FIG. 12 is a cross-section view of a container in accordance with the present invention.

FIG. 13 is an isometric view of a container and vial assembly in accordance with the present invention.

FIG. 14 is a side view of a combined device in accordance with the present invention.

FIG. 15 is a side view of a combined container and vial assembly in accordance with the present invention.

FIG. 16 is an exploded isometric view of a container and vial assembly in accordance with the present invention.

FIG. 17 is an exploded isometric view of a container and vial assembly in accordance with the present invention.

FIG. 18 is a top view of a container in accordance with the present invention.

FIG. 19 is an isometric view of a combined container and vial assembly in accordance with the present invention.

FIG. 20 is a cross-section side view of a container in accordance with the present invention.

FIG. 21 is a cross-section side view of a container in accordance with the present invention.

FIG. 22 is a cross-section side view of a container in accordance with the present invention.

### DETAILED DESCRIPTION OF THE INVENTION

The present application is a non-provisional application of U.S. provisional application No. 60/743,348 which was filed on Feb. 23, 2006 and is herein incorporated by reference for all purposes.

The present invention provides a test strip container for the safe and sanitary storage of used test strips until such a time as they may be disposed of properly (e.g. by placing the container or individual strips into a trash or bio hazard disposal bin). In one embodiment the container for storing used diagnostic test strips comprises a base wall, a top wall, and a side wall defining an enclosed container space. The container has formed therein a test strip opening connecting the outside environment with the enclosed container space. The test strip opening is sized to receive a test strip and allow its passage from the outside environment to the enclosed container space. The test strip opening is: disposed on the container in a position to restrain a test strip disposed in the container space from falling out of the container through the test strip opening; shaped to restrain a test strip disposed in the container space from falling out of the container through the test strip opening; or both.

### Definitions:

The term “used test strip” as it is used herein is understood to mean a diagnostic test strip that has had a biological sample applied to it in order to perform a diagnostic test. For example, in one embodiment the diagnostic test strip is used in combination with a meter that calculates the presence of glucose with a blood sample applied to the test strip.

The term “enclosed container space” is herein understood to mean the space defined by the container's wall or walls. The enclosed container space is sized to receive a plurality of used test strips. In the embodiments described herein the container has a base wall, a top wall and a side wall defining the container space. In a preferred embodiment the container has a generally annular side wall, a base wall, and a top wall (or lid wall) enclosing the container space. It is herein understood, that depending on the geometry of the container, the container may comprise one or more walls depending on the geometry of the container. For example, the container may comprise a single wall defining the enclosed container space (e.g. where the container is round).

The term “plurality of test strips” as it is used with regard to the sizing of the enclosed container space is not particularly limited and is herein understood to mean at least two. However, logical integers of the same are herein contemplated. For example, the number of tests performed by a user may vary depending on the type of analyte the user desires to measure within a sample. If a user tests for the concentration of glucose within a blood sample, the number of tests will vary depending on the needs of individual users. This will depend on, inter alia, recommendations from their Doctor and on insurance coverage. For example a user may test the concentration of glucose within their blood once a day. In such a case, a preferred container will be sized to receive multiples of 7, for example 7, 14, 21, or 28. This allows a once-a-day tester to carry a disposal container that can be used in weekly multiples.

In preferred embodiments the container space is completely enclosed from the outside environment, except for access to the container space through a test strip opening disposed through a container wall. In embodiments where the container is adapted to fit onto and to be detachable from a test strip vial, it is preferred that the container space be enclosed by a side wall and base wall of the container and also by a surface of the vial (e.g. the exterior base wall of a vial).

The containers of the present invention have a test strip opening disposed through a wall of the container that is sized to receive a test strip. The term “sized to receive a test strip” is herein understood to mean that the test strip opening is sized to allow a test strip's passage from the outside environment into the enclosed container space. The test strip opening is shaped and/or is disposed at a position through a wall of the container such that a test strip disposed in the container space is restrained from freely falling out of the container without the aid of a separate cover for the test strip opening.

The term “restrained from falling out of the container” as it is used with regard to a test strip and the shape and/or position of the test strip opening through a wall of the container is herein understood to mean, that the shape of the opening and/or the placement of the opening about a wall or internal structure of the container is selected such that after a test strip is received into the container space it may not fall out of the container, through the test strip opening, without manipulation of the container and/or the test strip within the container. In preferred embodiments, once a test strip is received within the container space, it cannot come out of the enclosed container space through the test strip opening.

In some embodiments the test strip opening will be formed through a container wall such that a test strip is slidably received through test strip opening. The term “slidably receive” as it is used in the present embodiments, is herein understood to mean that the test strip opening is formed such that force is required to push the test strips through the opening. Preferably the fit between the test strip and the test strip opening is loose enough to allow a user to slide the test strip through the test strip opening and into the container space with minimal force and without breaking the test strip, for example, the force applied by one finger of a user.

In one embodiment an opening is shaped to receive a test strip such that upon insertion, the test strip is momentarily bent and then regains its shape after it is fully received in the container space. In another embodiment, an opening is made through a wall of the container such that when the test strip is inserted into the container space it deflects against a wall or an internal structure disposed within the container space such that after full insertion it regains its original shape within the container space. In another embodiment an opening is disposed at an angle with respect to the base wall of the container such that a test strip will not easily re-find the opening after it is inserted into the container space. In another embodiment, an opening is disposed at an elevated position with respect to the base wall such that a test strip resides in the container space below the opening. In another embodiment an internal structure is disposed within the container space which acts to prevent test strips disposed in the container space from residing near the test strip opening. In yet another embodiment the container may comprise a plurality of test strip openings wherein each may be selected from any combination of the embodiments listed herein.

### Intersecting Test Strip Openings:

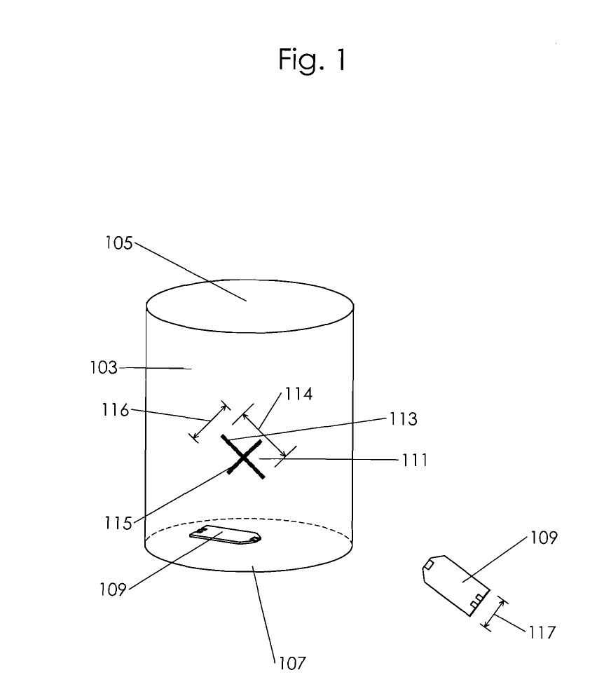

As illustrated in the embodiment shown in FIG. 1, a used test strip container 101 has an annular side wall 103 and a base wall 107 defining a used test strip space 105. A used test strip 109 may be introduced into space 105 through intersecting test strip openings 111. In the present embodiment intersecting test strip openings 111 are made from intersecting cuts 113, 115 that extend through wall 103 of container 101 into space 105.

The intersecting cuts 113, 115 may be of varying lengths 114, 116. In one embodiment the lengths 114, 116 of the openings 113, 115 will be the width 117 of various diagnostic test strips sold in industry. Thus container 101 may be used for receiving more than one type of test strip 109 available to consumers.

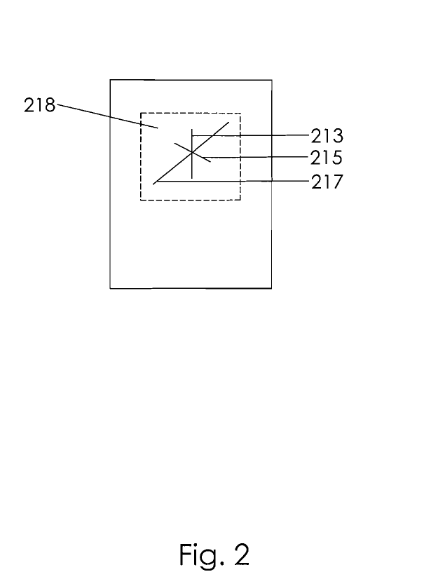

In the embodiment shown in FIG. 1 the number of the number of test strip openings 113, 115 disposed on the container is two. In another embodiment shown in FIG. 2, the container also comprises a plurality test strip openings. Here, there are three intersecting test strip openings 213, 215, 217. The number of the plurality of intersecting test strip openings is not particularly limited so long as the area 218 from which the intersecting test strip openings are cut from preferably remains rigid.

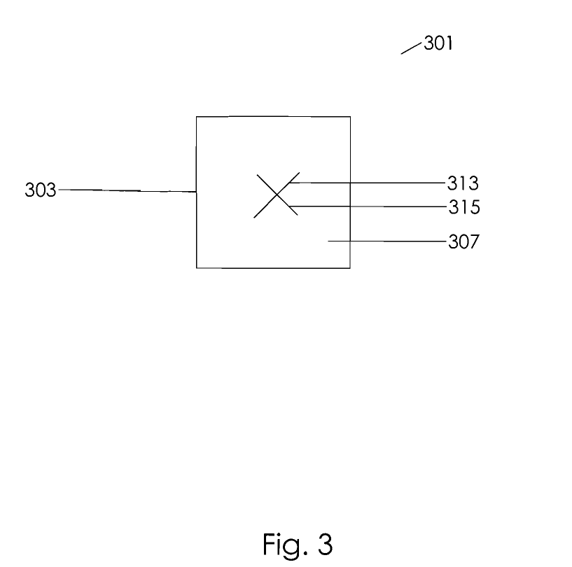

As shown in FIG. 3, the plurality of intersecting test strip openings 313, 315 may also be disposed through the base wall 307 of the container 301. In the embodiment shown in FIG. 3, the container 301 has a rectangular side wall 303.

### Step-Down Test Strip Openings and Slanted Test Strip Openings:

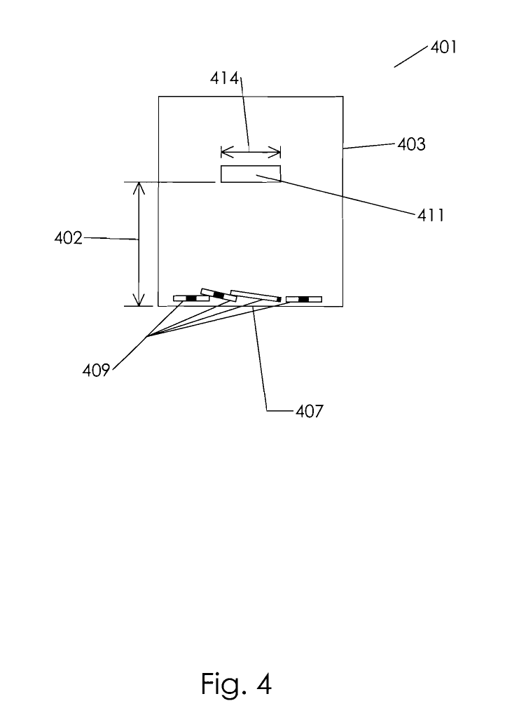

As illustrated in FIG. 4, in another embodiment of the present invention a container 401 has a test strip opening 411 positioned through the side wall 403 of the container 401 such that there is a step-down region 402 to the base wall 407 where a plurality of used test strips 409 reside. In one embodiment the test strip opening is disposed closer to the top wall than the base wall.

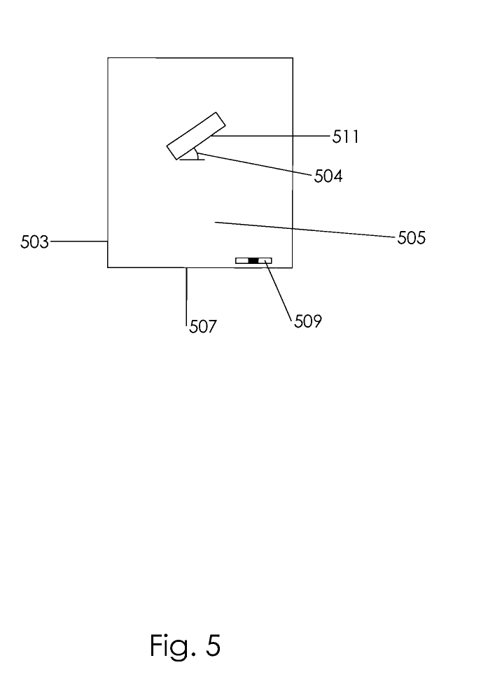

The cut 411 may be formed through the wall of the container 401 wherein the length 414 of opening 411 is parallel with the base wall 407. However, as shown in FIG. 5 it is preferable that a cut 511 be formed through the side wall 503 at an angle 504 that is not parallel with or is oblique to the base wall such that a test strip 509 will find it difficult to re-find the opening 511 after it is placed into the test strip space 505.

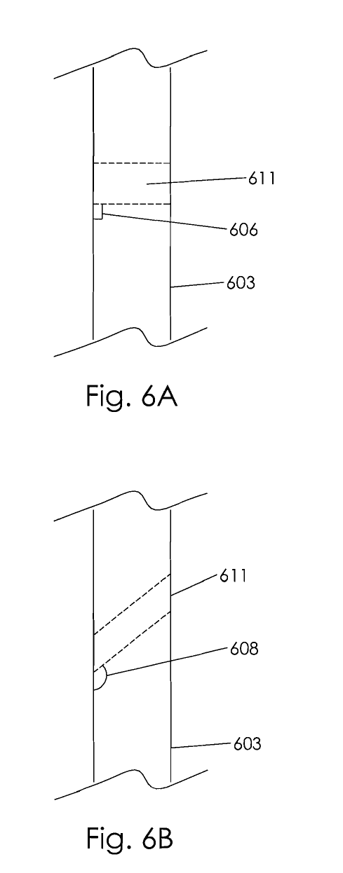

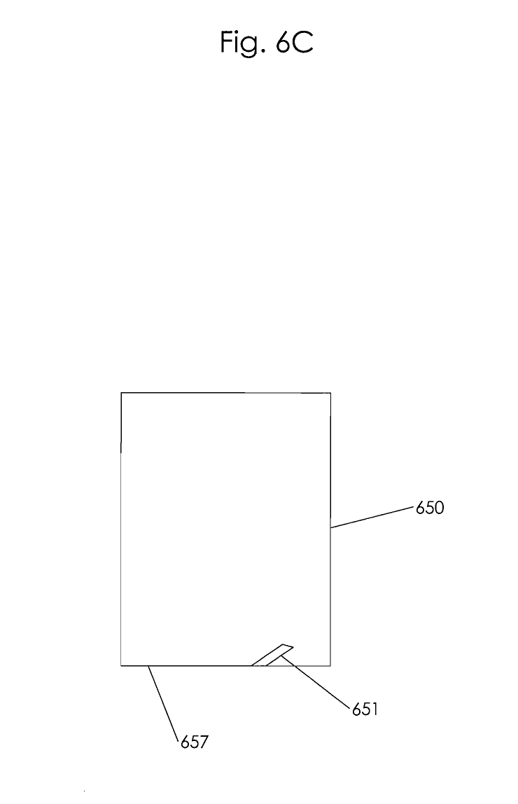

As shown in FIGS. 6A and 6B, opening 611 may be formed through a container wall 603 at an perpendicular angle 606 to the wall 603 (FIG. 6A) or at an oblique angle 608 with respect to the wall 603 (FIG. 6B).

In another embodiment shown in FIG. 6C a slanted cut 651 may be formed through a side wall 650 at the intersection of the side wall and the base wall 657 and the side wall 650 without a step down region. Here slanted cut 651 allows strips to be inserted at an angle with respect to the base wall. After insertion the strip will preferably fall flat along base wall 657.

### Shape of the Test Strip Opening:

The shape of the test strip opening is not particularly limited other than that it is sized to receive a test strip and allow its passage from the outside environment to the enclosed container space. However, in certain embodiments the test strip opening is shaped to restrain a test strip disposed in the container space from falling out of the container through the test strip opening. In these later embodiments of the present invention it is preferred that the test strip opening be sized and shaped to slidably receive the test strip through the test strip opening.

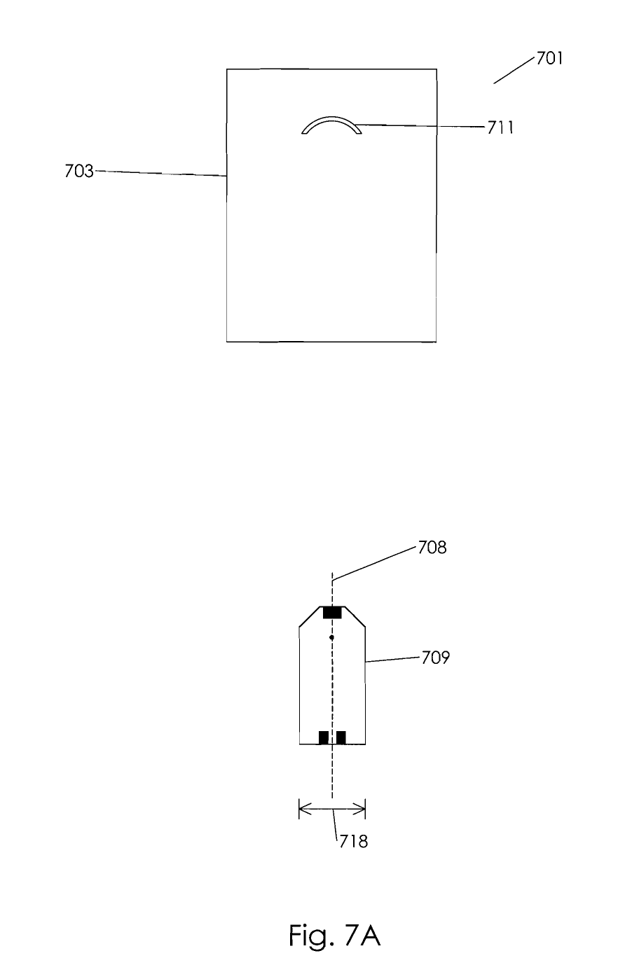

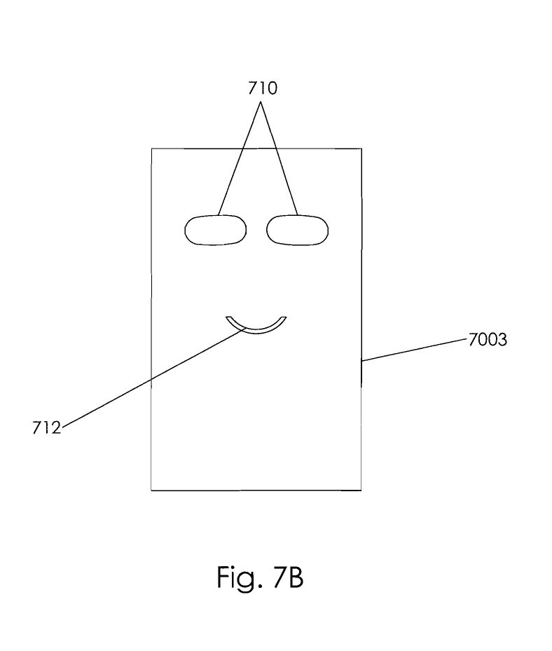

As illustrated in FIG. 7A, the test strip 709 will be inserted into the container 701 through a test strip opening 711 that is sized and shaped to slidably receive the test strip 709. Test strip opening 711 is cut through wall 703 so that the test strip 709 bends or arcs about its length axis 708 against a wall 703 at the opening 711 while being inserted into the container 701. After the test strip 709 is inserted into the container 701 through the opening 711 it resumes its original shape and may not come out of the container 701 through opening 711. The curved cut may be formed in any wall of the container, including the base wall. The opening may be any shape of arc or circle such that the test strip is slidably received by the opening and is bent about an axis, preferably along its longest axis, upon insertion. For example if the opening is a circle, the diameter of the circle should be shorter in length than the width 718 of a test strip 709 with the proviso that the strip 709 may fit within the opening. If the opening is and arc, its radius of curvature will be that which deflects the test strip about an axis, preferably its longest axis (i.e. its length axis) upon insertion into the container space.

In another embodiment shown in FIG. 7B the container 7003 has a plurality of test strip openings 710, 712. Test strip openings 710 are each a circle and test strip opening 712 is an arc 712. In the present illustration, the length of the arc and the diameter of the circles are of varying lengths so as the container may be used with test strips from different manufacturers.

In another preferred embodiment for a container of the present invention the material in the region of the test strip opening may be made from a deformable material, such as a resilient plastic that permits depression or deformation of the region and widening of the test strip opening as a user pushes the used strip into the container space. After the strip is received into the container space and as pressure is released, the test strip opening regains its initial position thereby preventing test strips from falling out of the container. In a preferred embodiment the test strip opening closes after release of pressure.

In some embodiments, the container has an interior structure that interacts with a test strip inserted into the container space that interacts with the shape and position of the opening to assist in restraining of the test strips. For example the interior of the container space may have a wall with a crowned surface, an internal structure, or a strip stop bump as discussed below.

### Test Strip Opening Formed to Deflect Test Strip Against Adjacent Wall or Internal Structure:

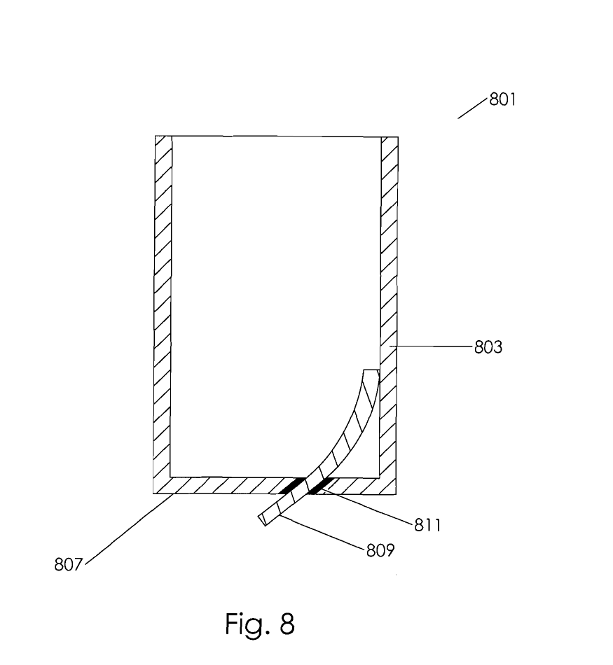

As illustrated in the cross-section of container 801 in FIG. 8, in another embodiment of the present invention a test strip 809 will be inserted through a test strip opening 811 that is formed in the base wall 807, at an oblique angle thereto so that the test strip 809 deflects against an adjacent wall, here sidewall 803 of the container 801 while being inserted. After the test strip 809 is inserted into the container 801 through the opening 811 it resumes its original shape and may not come out of the container 803 through the opening 811.

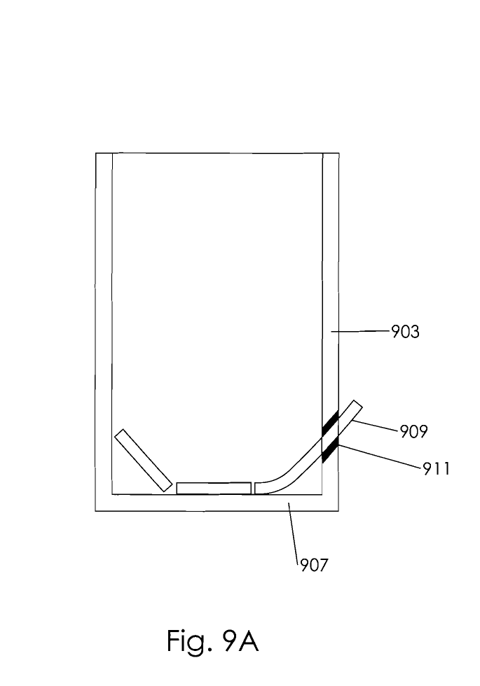

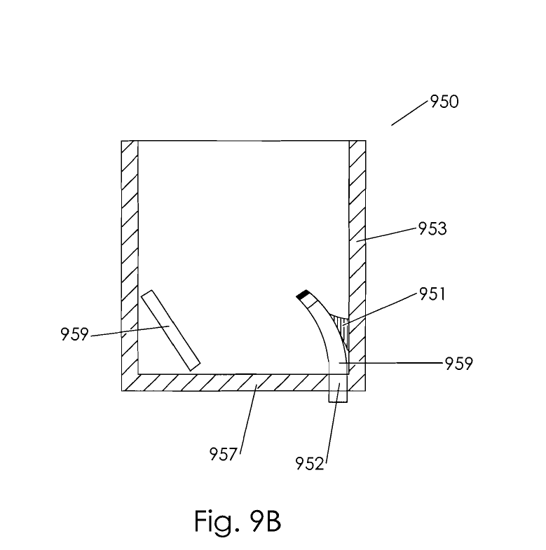

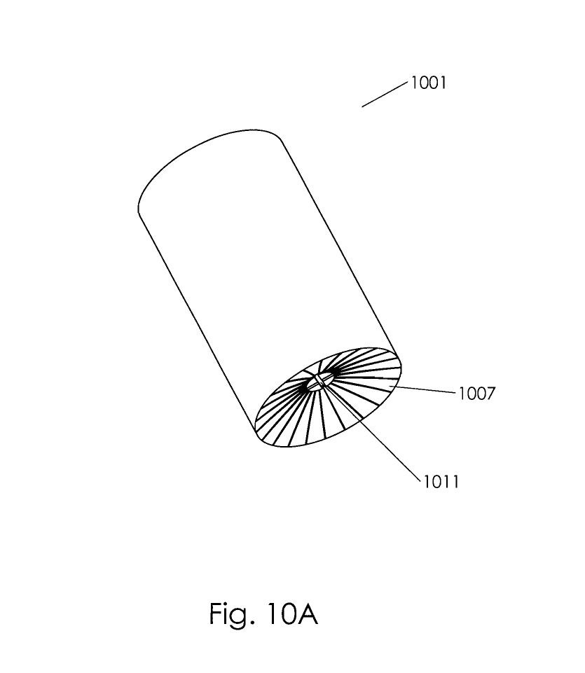

The test strip opening 811 may be formed in any wall of the container such that the test strips deflect against an adjacent wall of the container upon insertion. For example, as illustrated in FIG. 9A, the opening 911 may be formed at a position and at an oblique angle through side wall 903 such that the test strip 909 is deflected against base wall 907 upon insertion.

In another embodiment the test strip opening is disposed through a wall at or near the point of intersection with an adjacent wall, wherein the adjacent wall comprises a protrusion disposed at an interacting position within the container space whereby upon insertion of a test strip through the test strip opening, the test strip deflects against the protrusion. After the test strip is received through the test strip opening it regains its initial form and is prevent from falling out of the container due to the interaction of the test strip opening with the protrusion. For example as illustrated in FIG. 9B a protrusion 951 is formed on side wall 953 of container 950. Opening 952 is formed in the base wall 957, at or near the intersection of the base wall 957 with side wall 953, such that a test strip 959 deflects against protrusion 951 upon insertion. After full insertion of test strip 959 into container space 960 it regains its original shape.

### Wall having a Crowned Surface:

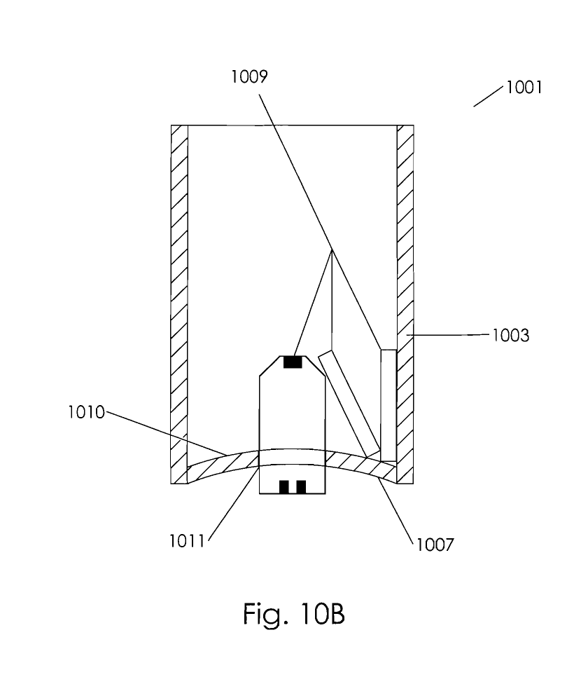

As illustrated in FIGS. 10A and 10B, in another embodiment a test strip opening 1011 may be disposed on the base wall 1007 of a container 1001. In the present embodiment, as shown in FIG. 10B the container has a crowned base wall 1007 extending within the container 1001. The term crowned is understood to mean a slanted or rounded surface. The crown has the effect of keeping the used test strips 1009, after insertion, away from the test strip opening 1011 and from unduly falling out of the container 1001. After a used strip 1009 is inserted into the container 1001 it slides along the crowned surface 1010 of base wall 1007 toward the side wall 1003 and away from opening 1011. The test strip opening 1011 may be any of the openings described above. As illustrated in FIG. 10A the container comprises two intersecting test strip openings 1011.

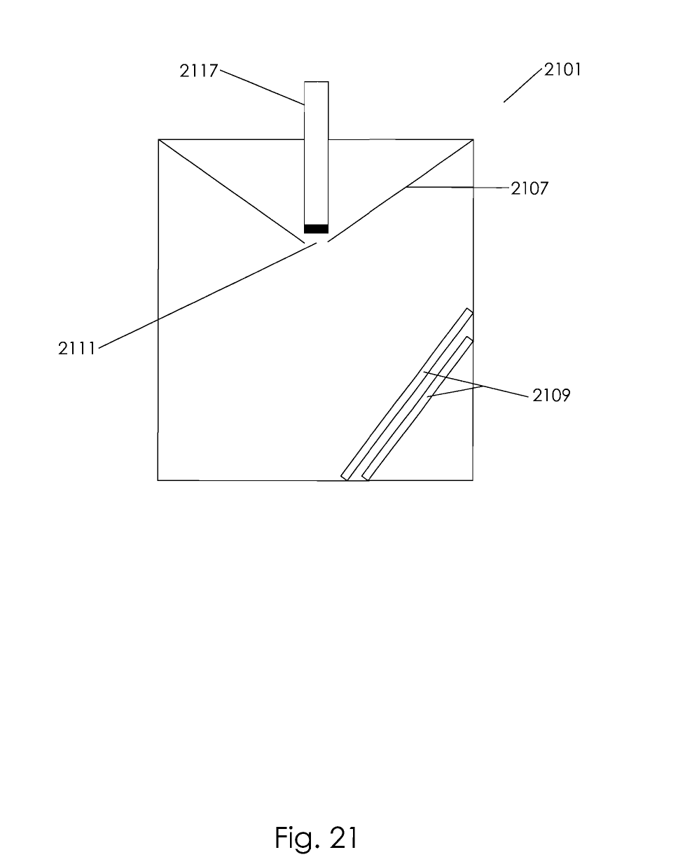

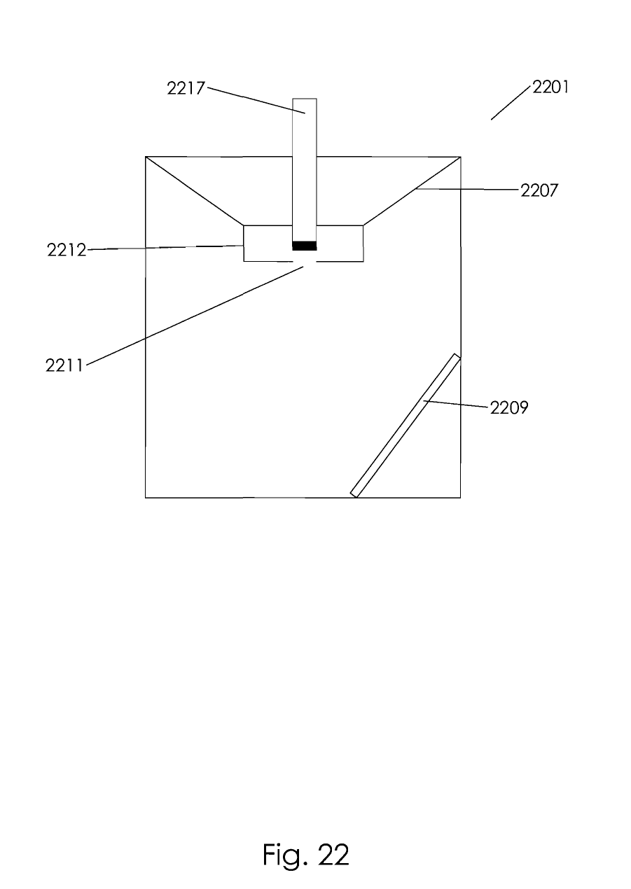

The crowned wall with the test strip opening may be formed on any of the walls. For example the crowned wall may be the top wall. As illustrated in the cross-section of container 2101 in FIG. 21, in another embodiment a test strip opening 2111 may be disposed through the top wall 2107 of a container 2101. In the present embodiment top wall 2107 is a slanted surface (e.g. conical). The slanted top wall 2107 directs a used test strip 2117 toward the test strip opening 2111 while keeping the used test strips 2109, after their insertion, away from the test strip opening 2111 and from unduly falling out of the container 2101. FIG. 22 illustrates another cross-section of a container 2201 where the top wall 2207 is partially slanted to direct a used test strip toward test strip opening 2211 while allowing room 2212 for finger to depress the test strip 2217 through the test strip opening 2211 and into the container 2201.

### Strip Stop Bump and Corresponding Test Strip Opening:

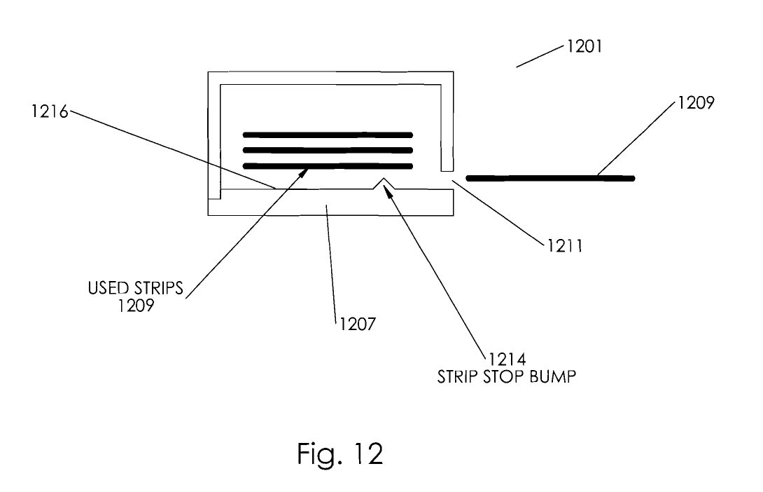

As illustrated in FIG. 12, in another embodiment container 1201 has a test strip opening 1211 corresponding with a strip stop bump 1214 formed on the container space side 1216 of the base wall 1207. When a used strip 1209 is placed through test strip opening 1211 of container 1201 it is prevented from falling out of container 1201 by strip stop bump 1214.

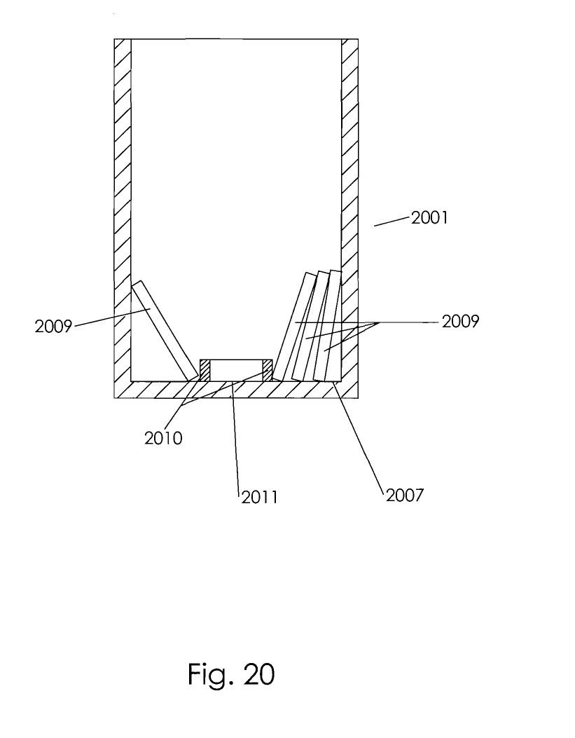

As illustrated in FIG. 20, a container 2001 has an opening 2011 disposed on the base wall 2007 of the container 2001 that is surround by a strip stop ridge 2010. After a strip is inserted strip stop ridge 2010 prevents strip 2009 from residing near opening 2011.

The used test strip containers of the present invention may be stand alone containers, they may be adapted to fit onto test strip vials (i.e. new strip compartments), or they may be formed integral with the same.

### Stand Alone Containers:

The containers described in any of the embodiments above may be stand alone containers used solely for the safe and sanitary storage of used test strips. A user may discard the entire container at any time and preferably when the container is full of used test strips. In one embodiment a wall of the container comprises a removable portion that can be removed to dump used test strips stored in the vial into an appropriate storage receptacle, such as a trash can or a bio hazard bin, and then replaced back onto the container so that the container may be reused.

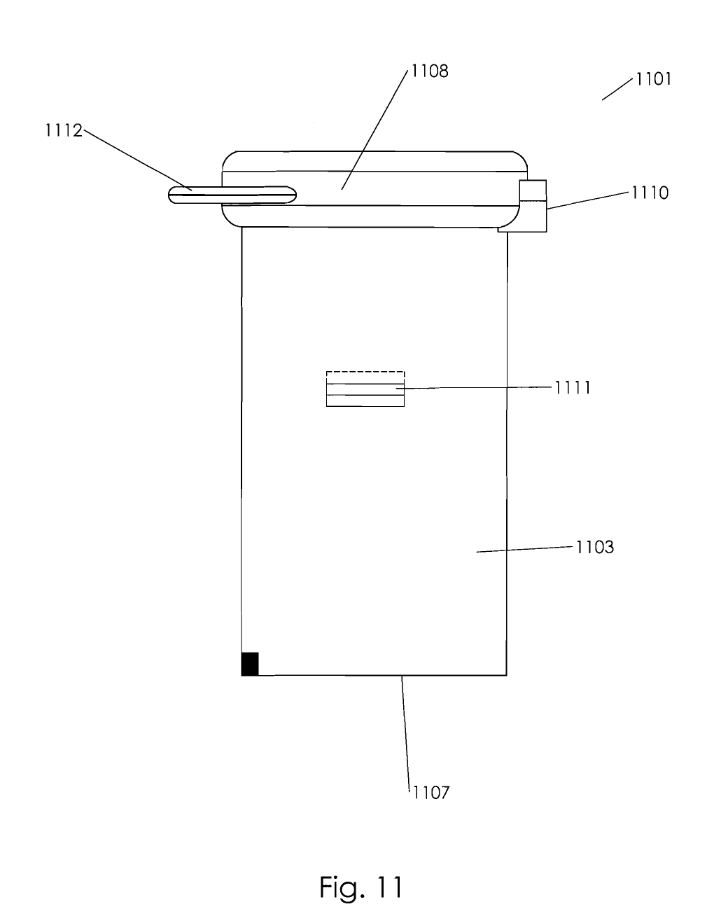

As shown in FIG. 11, a container 1101 has a slanted test strip slot 1111 extending at an oblique angle through wall 1103. The container 1101 has a base wall 1107 and a top wall here lid 1108. Lid 1108 is preferably attached to the container 1103 about hinge 1110, for example a living hinge, such that when lid 1108 is removed from its closed position (shown in FIG. 11) it remains attached to the container. Lid 1108 is preferably closed to container 1103 via a snap fit seal or by the male and female interaction of a protrusion and depression that allows a user to easily remove the lid 1108 from the container 1101 yet preventing the container 1103 from unexpectedly opening when such is not desired. A thumb limp 1112 is preferably placed at the edge of the lid 1108 to further facilitate the user's ability to open the container 1101. When a user desires to empty used test strip from the container 1101 she simply opens lid 1108 and dumps the used test strips from the container 1101.

In a particularly preferred embodiment where the container is reusable, a user will be able to decorate the container such that it is personalized, or order the container to be made of a precious metal such as gold or platinum. In another embodiment the container has an exterior appearance of something other than what it is. Namely, the exterior appearance of the test strip container will be that of an object used daily, such as a pen, lipstick, or eyeliner.

Containers Adapted to Attach Onto a Test Strip Vials (i.e. Compartments Containing New Strips):

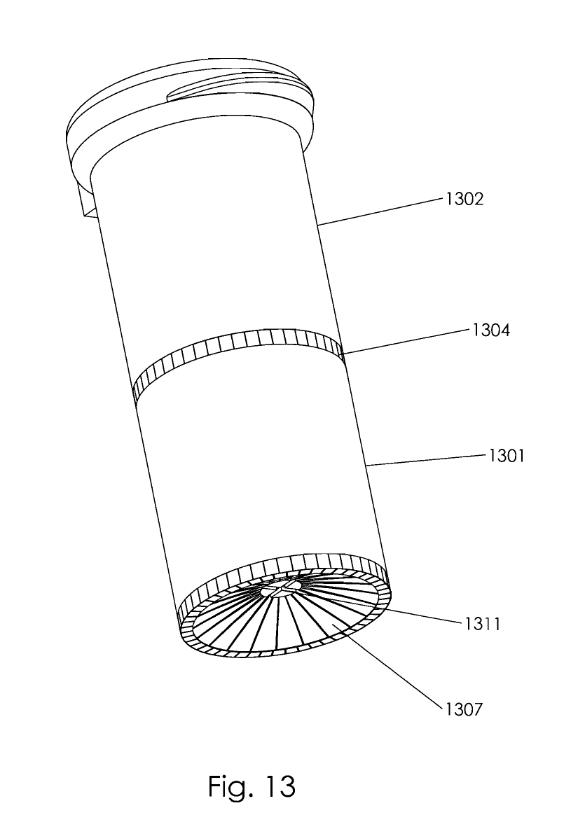

The containers described in the embodiments above may be adapted to further comprise compartments for the storage of new and unused test strips. For example, the container of the present invention may be adapted to fit onto a test strip vial to form a combined assembly. The test strip vial portion of the assembly is not particularly limited as it may be, for a non-limiting example, a vial of the past or a new vial adapted to receive the containers of the present invention. As illustrated in FIG. 13 a container 1301, described above, will have a mechanism 1304 for attaching to the vials 1302 of the past. Mechanism 1304 may be a snap fit seal that allows the container 1301 to snap onto the vial 1304, or it 1304 may be, inter alia, a rubber gasket, flange, or o-ring that holds container 1301 to vial 1302. As shown in this embodiment container 1301 has a crowned base wall 1307 having a plurality of intersecting cuts for its opening 1311 disposed on the crowned base wall 1307.

The placement of the container relative to the vial is not particularly limited. For example, the container may be attached to the lid of the vial, the base of the vial or along side the vial. Preferably, the container will be sized to fit on the lid or the base of the vial such that it appears to be integral with the vial.

In one embodiment the base wall of vial 1302 provides the top wall or the lid of container 1301 thereby further defining the enclosed container space. Here a user may remove and dump the container 1301 at any time or when it is full of used test strips. Or a user may simply discard the entire container 1301 at any time. In another embodiment the container 1301 has a top wall that makes it completely sealed and safely disposable in a trash bin.

In another embodiment, container 1301 is sold to a user containing new and unused test strips disposed therein. A user then may use the unused test strips to refill the vial 1302, while being able to use the container 1301 as a new container 1301 for subsequently disposing the used test strips.

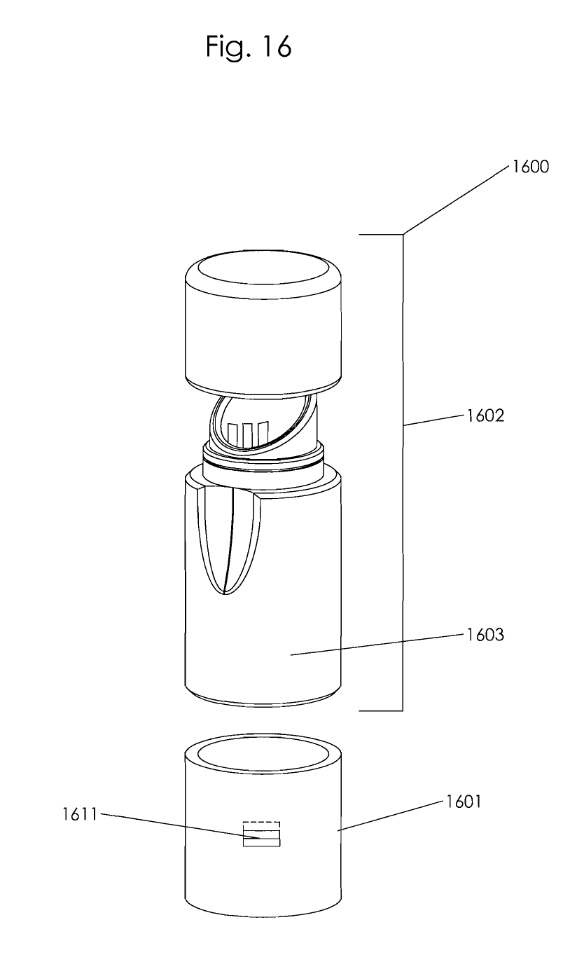

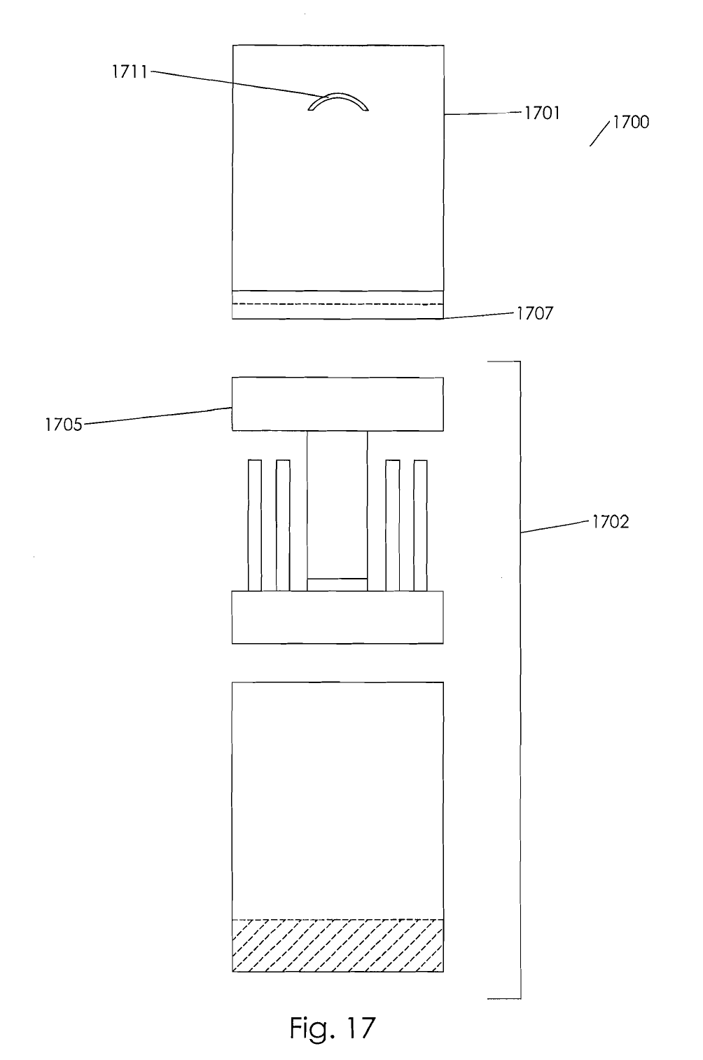

As stated above, the vials onto which the test strip containers described above may be attached are not particularly limited. For example, the test strip vials disclosed in U.S. patent application Ser. No. 11/249,093 and 11/252,959 provide exemplary candidates and are herein incorporated by reference for all purposes. FIGS. 16 and 17 show embodiments of the present invention wherein a container is attached to vial embodiments disclosed in the aforementioned patent applications thereby forming combined assemblies.

As detailed in FIG. 16, a used test strip container 1601 described above may be adapted to fit on a test strip vial 1602 embodiment shown in FIG. 1 of U.S. patent application Ser. No. 11/249,093, thereby forming a combined assembly 1600. Here container 1601 is sized to snap fit onto the base 1603 of vial 1602. Container 1601 here has a slanted cut 1611 formed therein for the used test strip opening.

As detailed in FIG. 17, a used test strip container 1701 described above may be adapted to fit on a test strip vial 1702 embodiment shown in FIG. 1E of U.S. patent application Ser. No. 11/252,959, thereby forming a combined assembly 1700. Here container 1701 is sized to rest on lid 1705 of vial 1702, while a rubber o-ring 1707 holds container 1701 to the lid 1705. Container 1701 here has a curved cut 1711 formed therein for the used test strip opening.

### Containers may be Formed Integral with a Test Strip Vial:

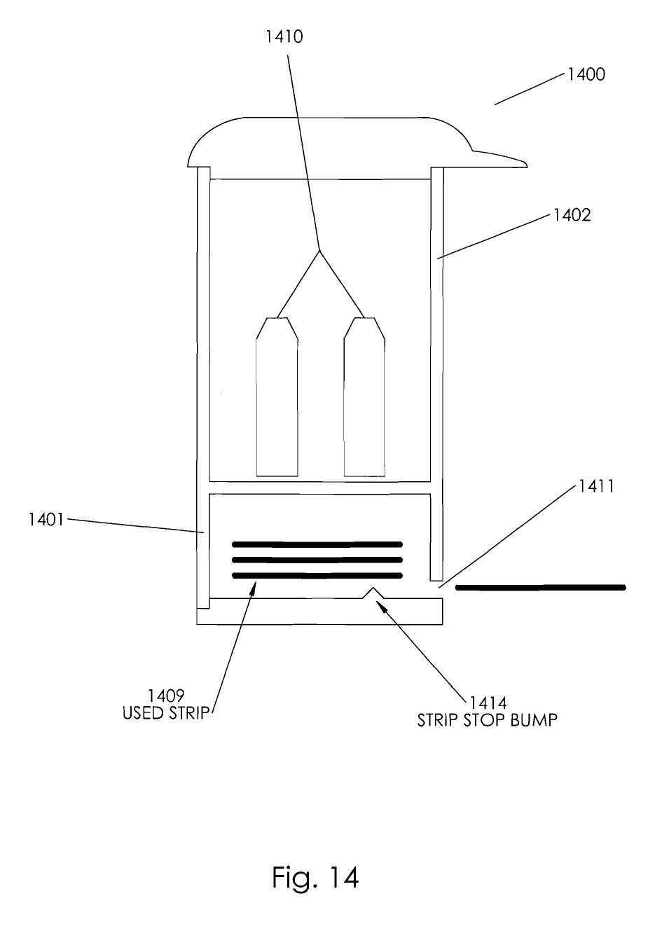

The containers described in the embodiments above may be formed integral with test strip vials. It is to be herein understood to mean that a container that is formed integral with test strip vial has a formed housing defining a new test strip compartment and a separate used test strip container. As illustrated in FIG. 14 any of the containers 1401, described above may be formed integral with a test strip vial 1402 thereby forming a combined new and used strip storage container 1400. As shown in this embodiment, container 1401 has a test strip opening 1411 corresponding with a strip stop bump 1414 described above. Vial portion 1402 has a plurality of new and unused test strips 1410 disposed therein while container portion 1401 is sized to receive a plurality of used test strips 1409.

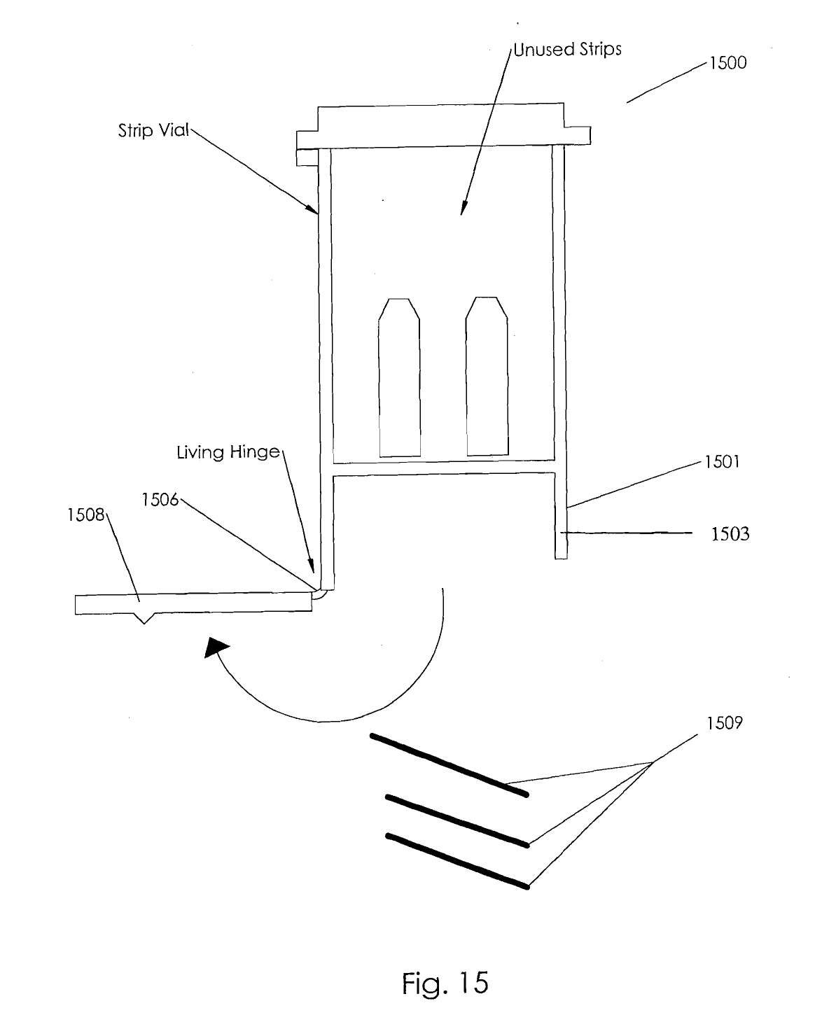

As illustrated in FIG. 15, the container portion 1501, further comprises a removable lid 1508 connected to the combination 1500 via a living hinge 1506. When lid 1508 is opened, as depicted in this FIG., used test strip 1509 may be removed from the combination 1500. The test strip opening may be disposed through the lid 1508 or through a wall 1503 according to any of the embodiments illustrated herein.

### Geometry:

In accordance with the above embodiments, the containers may be any shape such that the container is sized to receive a test strip within its container space. Preferably the container space will be defined to be generally annular in shape. However, it is herein contemplated that the container space will be defined by a rectangular or spherical wall thereby defining a cube-like or spherical container space respectively.

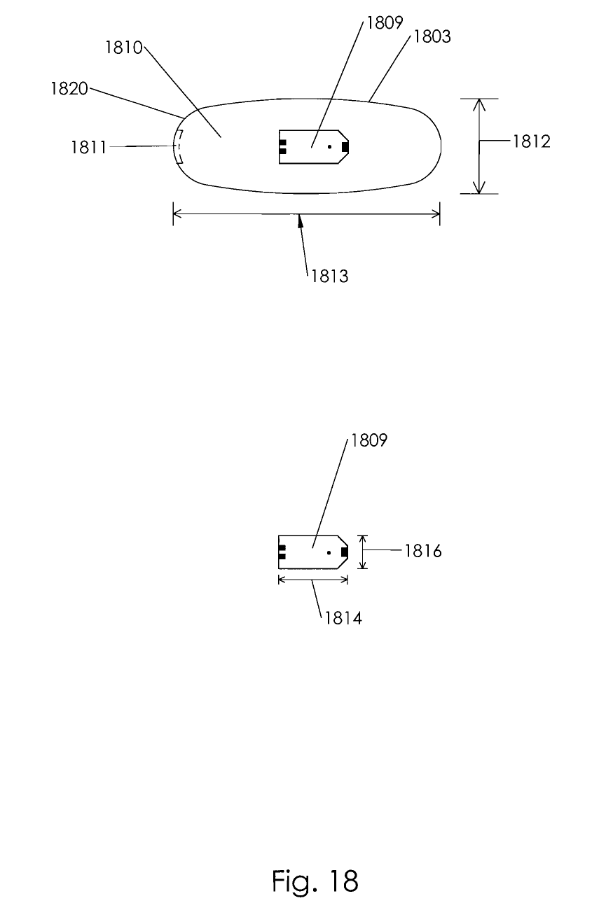

In an embodiment shown in the top view of container 1801 in FIG. 18, the container space 1810 is defined by a generally annular wall 1803 wherein the thickness 1812 of the container space 1810 is smaller than the length 1814 of a diagnostic test strip 1809. The width 1813 of the container space 1810 is longer than both the length 1814 and the width 1816 of a diagnostic test strip 1809. In this embodiment, the test strips 1809 reside within the container space 1810 along the bottom of the container 1801 and along its width 1813 while the test strip opening 1811 resides at the edge 1820 of the container 1801. When the test strip 1809 is inserted into the container 1801 it aligns itself with other test strips 1809 therein disposed.

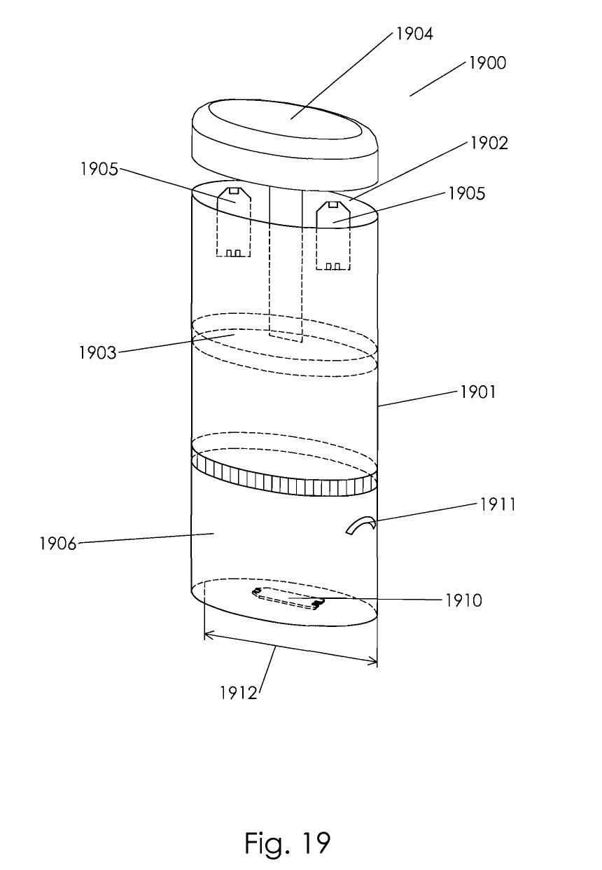

A container as described with reference to FIG. 18 above may also be designed to fit onto a vial 1901 or formed integral with a vial 1901 to form a combined assembly 1900 as shown in FIG. 19. Vial 1901 is described in U.S. patent application Ser. No. 11/252,959. Vial 1901 is general annular in shape with an oval opening 1902. New test strips 1905 are positioned on a lifting tray 1903 such that when lid 1904 is removed from vial 1901 they are raised toward the opening 1902 and away from container 1906. After a user uses a test strip they may place it into container 1906 through opening 1911 disposed on the side of container 1906. Here opening 1911 is an arc opening as described above that allows the passage of a test strip 1910 along the length 1912 of the container 1906. In a preferred embodiment, used test strip(s) 1910 will reside in the container 1906 at an angle perpendicular to new test strips 1905.

### Operation:

The present invention further provides a method for using the containers of the present invention where the container further comprises a new and unused test strip compartment. The method comprising the steps performed by a user of:

(i) opening the unused test strip compartment,

(ii) removing an unused test strip from the unused test strip compartment,

(ii) using the test strip by applying a sample thereto, and

(iii) returning the used test strip to the enclosed container space through the test strip opening.

### Construction:

The material of construction of the containers of the present invention is not particularly limited. Due to the ease of and cost of manufacture it is often preferred that the containers be made from a thermoplastic resin such as polycarbonate. The containers described herein may be formed by injection molding, blow molding, or compression molding are any combination thereof.

In a preferred embodiment the containers of the present invention will be made of a material that allows a user to visually determine how many used test strips are disposed within the container. For example, a wall of the container will comprise a transparent material, such as a clear polycarbonate.

### Test Strips:

Test strips that are suitable for use with any of the embodiments of the present invention are not limited. For example, test strips that are suitable for use with the embodiments of the present invention are disclosed in U.S. application Ser. No. 10/908,656, which is herein incorporated by reference. Numerous test strips are also commercially sold. For example, test strips sold under the Accu-Check, One Touch Ultra, and Freestyle trademarks are all suitable for use with the containers and assemblies of the present invention.

1. A storage container for storing used diagnostic test strips, the container comprising a base wall, a top wall, and a side wall defining an enclosed container space, wherein
the container has formed therein a test strip opening connecting the outside environment with the enclosed container space, wherein the test strip opening is sized to receive a test strip and allow its passage from the outside environment to the enclosed container space, and wherein
the test strip opening is: disposed on the container in a position to restrain a test strip disposed in the container space from falling out of the container through the test strip opening; shaped to restrain a test strip disposed in the container space from falling out of the container through the test strip opening; or both.

2. The container of claim 1, wherein the test strip opening is disposed through the side wall of the container at a position between the top and base walls and wherein the slot is disposed closer to the top wall than the base wall.

3. The container of claim 1, wherein the test strip opening is formed at an oblique angle with respect to an adjacent wall.

4. The container of claim 1, wherein the test strip opening is formed at an oblique angle through a wall.

5. The container of claim 4, wherein the test strip opening is disposed at a position relative to an adjacent wall such that a test strip is deflected by the adjacent wall upon insertion of the test strip through the test strip opening and regains its initial shape after insertion into the enclosed container space.

6. The container of claim 1, wherein container further comprises an interior structure that interacts with the shape and position of the opening to restrain test strips disposed in the container space from falling out of the container through the opening.

7. The container of claim 6, wherein a wall comprises a crowned surface extending into the interior of the container space, and wherein the test strip opening is disposed through the crowned surface.

8. The container of claim 6, wherein the test strip opening is disposed at a position on a wall at the point of intersection with an adjacent wall, and wherein the adjacent wall comprises a protrusion disposed at an interacting position within the container space whereby upon insertion of a test strip through the test strip opening, the test strip deflects against the protrusion.

9. The container of claim 1, wherein the shape of the test strip opening is selected from the group consisting of: a hole having a diameter less than the width of a test strip; an arc having a radius of curvature that deflects a test strip about an axis of the test strip upon insertion into the container; and a rectangular slot.

10. The container of claim 1, wherein the test strip opening is sized to slidably receive a test strip and wherein the test strip opening is made from a deformable material that deforms to allow passage of the test strip into the container space and regains its original form after insertion of the test strip into the container space.

11. The container of claim 10, wherein the container comprises a plurality of test strip openings.

12. The container of claim 11, wherein two or more test strip openings intersect.

13. A storage container for storing used diagnostic test strips, the container comprising a base wall, a top wall, and a side wall defining an enclosed container space, wherein
the container has formed therein a test strip opening connecting the outside environment with the enclosed container space, wherein the test strip opening is sized to receive a test strip and allow its passage from the outside environment to the enclosed container space,
the test strip opening is: disposed on the container in a position to restrain a test strip disposed in the container space from falling out of the container through the test strip opening; shaped to restrain a test strip disposed in the container space from falling out of the container through the test strip opening; or both, and
the container further comprising an unused test strip compartment comprising a plurality of unused test strips.

14. The container of claim 13, wherein the unused test strip compartment is detachable from the container.

15. The container of claim 13, wherein the unused test strip compartment is formed integral with the container.

16. The container of claim 13, wherein the test strip opening is disposed through the side wall of the container at a position between the top and base walls and wherein the slot is disposed closer to the top wall than the base wall.

17. The container of claim 13, wherein the test strip opening is formed at an oblique angle with respect to an adjacent wall.

18. The container of claim 13, wherein the test strip opening is formed at an oblique angle and through a wall.

19. The container of claim 18, wherein the test strip opening is disposed at a position relative to an adjacent wall such that a test strip is deflected by the adjacent wall upon insertion of the test strip through the test strip opening and regains its initial shape after insertion into the enclosed container space.

20. The container of claim 13, wherein container further comprises an interior structure that interacts with the shape and position of the opening to restrain test strips disposed in the container space from falling out of the container through the opening.

21. The container of claim 20, wherein a wall comprises a crowned surface extending into the interior of the container space, and wherein the test strip opening is disposed through the crowned surface.

22. The container of claim 20, wherein the test strip opening is disposed at a position on a wall at the point of intersection with an adjacent wall, and wherein the adjacent wall comprises a protrusion disposed at an interacting position within the container space whereby upon insertion of a test strip through the test strip opening, the test strip deflects against the protrusion.

23. The container of claim 13, wherein the shape of the test strip opening is selected from the group consisting of: a hole having a diameter less than the width of a test strip; an arc having a radius of curvature that deflects a test strip about an axis of the test strip upon insertion into the container; and a rectangular slot.

24. The container of claim 13, wherein the test strip opening is sized to slidably receive a test strip and wherein the test strip opening is made from a deformable material that deforms to allow passage of the test strip into the container space and regains its original form after insertion of the test strip into the container space.

25. A method of using a storage container for storing used diagnostic test strips, the container comprising a base wall, a top wall, and a side wall defining an enclosed container space, the container further comprising an unused test strip compartment comprising a plurality of unused test strips, wherein
the container has formed therein a test strip opening connecting the outside environment with the enclosed container space, wherein the test strip opening is sized to receive a test strip and allow its passage from the outside environment to the enclosed container space, and
the test strip opening is: disposed on the container in a position to restrain a test strip disposed in the container space from falling out of the container through the test strip opening; shaped to restrain a test strip disposed in the container space from falling out of the container through the test strip opening; or both, and
the method comprising the steps performed by a user of:
(i) opening the unused test strip compartment,
(ii) removing an unused test strip from the unused test strip compartment,
(ii) using the test strip by applying a sample thereto, and
(iii) returning the used test strip to the enclosed container space through the test strip opening.
